(19) United States
(12) Patent Application Publication
(10) Pub. No.: US 2026/0352698 A1
(43) Pub. Date: Nov. 5, 2026

(54) HALOFRAME AI Manipulation Detection and Override System

(71) Applicant: Robert Quinn, George Town (KY)

(72) Inventor: Robert Quinn, George Town (KY)

(21) Appl. No.: 19/383,872

(22) Filed: Nov. 10, 2025

Related U.S. Application Data
(63) Continuation-in-part of application No. 19/197,998, filed on May 3, 2025, now abandoned.

(51) Int. Cl. H04L 9/40; G10L 17/26

(52) U.S. Cl. CPC H04L 63/1441; G10L 17/26

(57) ABSTRACT

HALOFRAME™ is a multi-layered AI safety and override system designed to detect, score, and neutralize harmful or deceptive AI-generated content in real time. The system includes context-aware risk analysis, user alerts, override controls, replay evidence packaging, and covert activation modes. It supports browser overlays, video timelines, voiceprint detection, dual-profile toggling, offline device synchronization, and block source enforcement. The platform operates across phones, wearables, browsers, and embedded systems to provide transparent visibility and active control over AI-driven threats.

### TECHNICAL FIELD

The present disclosure relates to artificial intelligence safety systems, and more particularly to systems and methods for detecting, scoring, visualizing, and overriding synthetic, deceptive, or manipulative AI-generated content across digital environments.

### BACKGROUND

The rapid deployment of artificial intelligence systems across communication platforms has introduced new vectors for manipulation, impersonation, misinformation, and automated deception. Existing security tools are generally reactive, opaque, or limited to narrow threat categories, leaving users without meaningful visibility or control over AI-driven interactions. There is a need for a unified system that can identify AI-related threats in real time, present intelligible warnings, and enable active intervention while preserving user privacy and evidentiary integrity.

### SUMMARY

HALOFRAME™ is a multi-layered AI safety and override system designed to detect, score, and neutralize harmful or deceptive AI-generated content in real time. The system integrates context-aware risk analysis, escalating user alerts, control override mechanisms, replay and evidentiary packaging, covert activation modes, and cross-device privacy controls. HALOFRAME™ operates across phones, wearables, browsers, and embedded systems to provide transparent visibility and active user control over AI-driven threats.

### BRIEF DESCRIPTION OF THE DRAWINGS

FIG. 1 illustrates the overall system architecture of AI AWARE™, showing user device input through local analysis, scoring, alerting, override, and advanced protection modules.

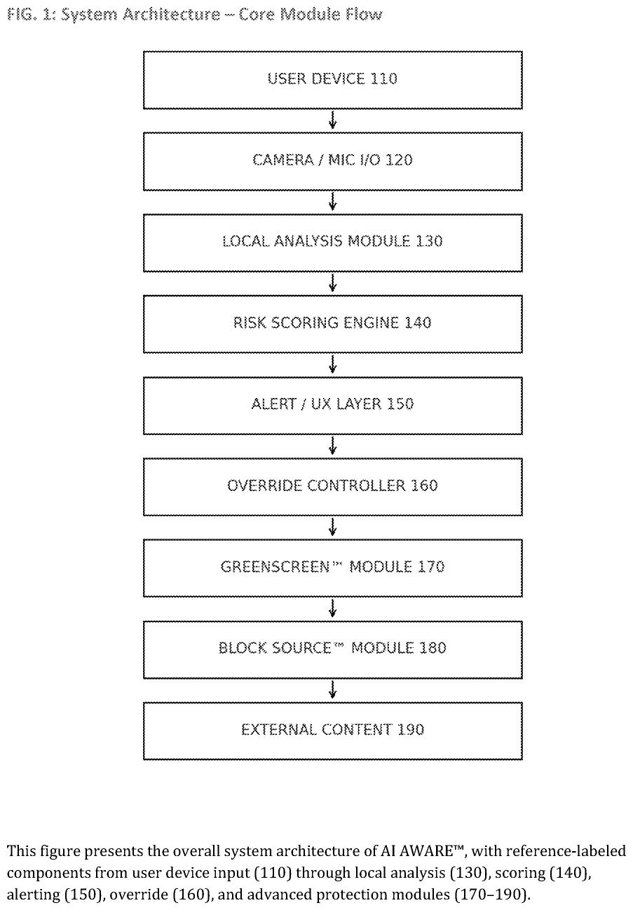

FIG. 2 illustrates a context-aware risk scoring pipeline including voice and video input, preprocessing, contextual evaluation, scoring, threshold testing, and alert or override triggering.

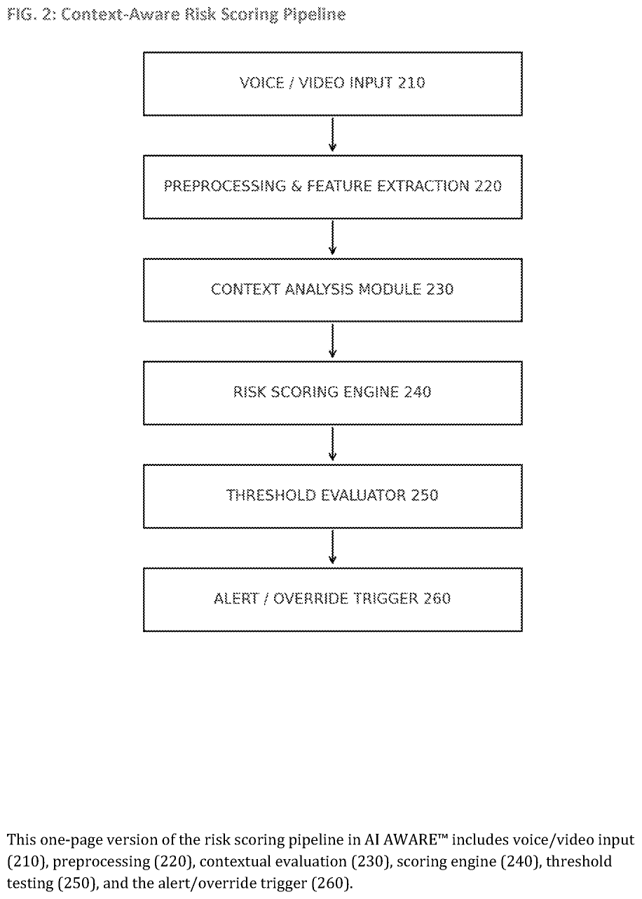

FIG. 3 illustrates a voiceprint warning sequence capturing voice input, performing match analysis, checking thresholds, and escalating alerts.

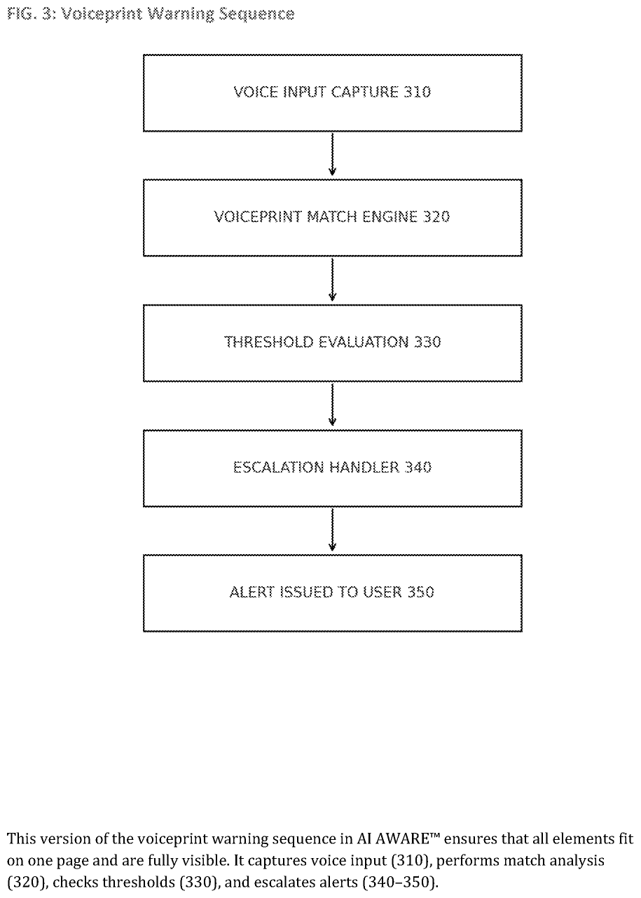

FIG. 4 illustrates a freeze interaction state flow transitioning from idle to monitoring, frozen state, authorized unfreeze, and resumed monitoring.

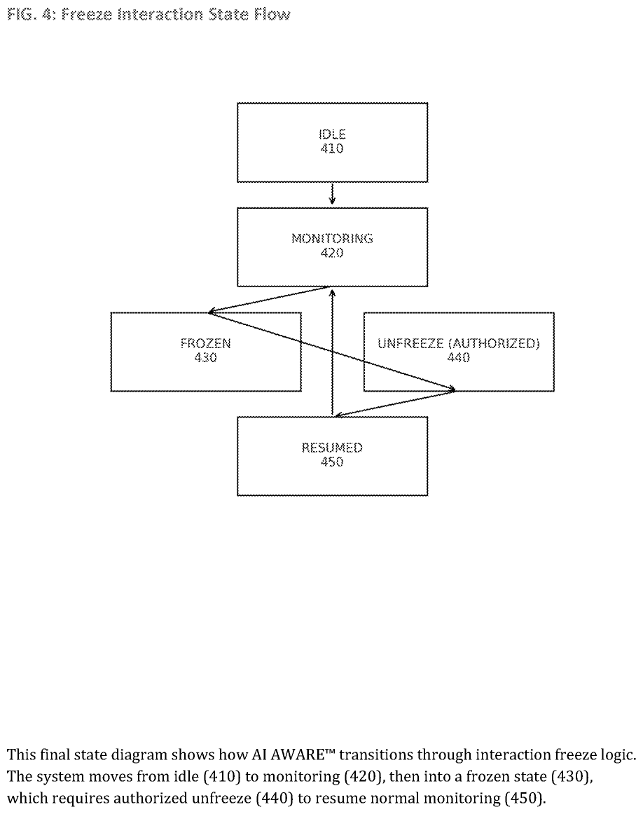

FIG. 5 illustrates a replay mode workflow including session capture, redaction of personal information, signing and hashing, evidence packaging, and secure export.

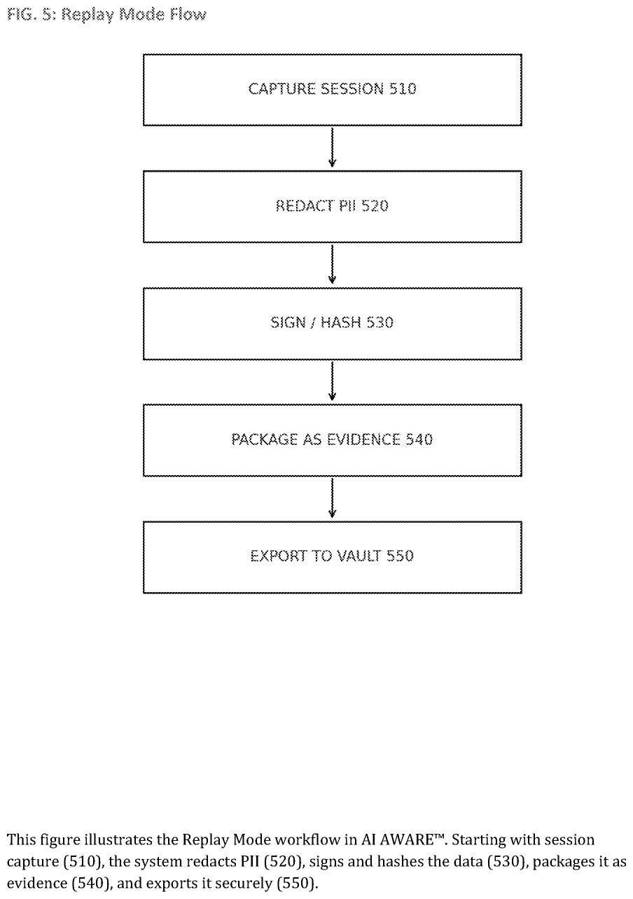

FIG. 6 illustrates a browser and video flagging system with badge overlays, tooltips, and timeline-based visual cues identifying manipulated content.

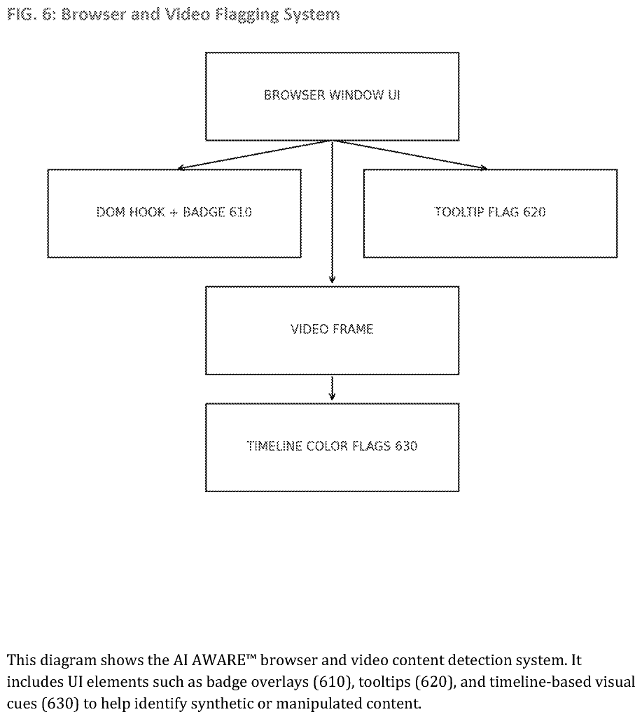

FIG. 7 illustrates a covert mode and screenshot jammer sequence triggered upon screenshot detection.

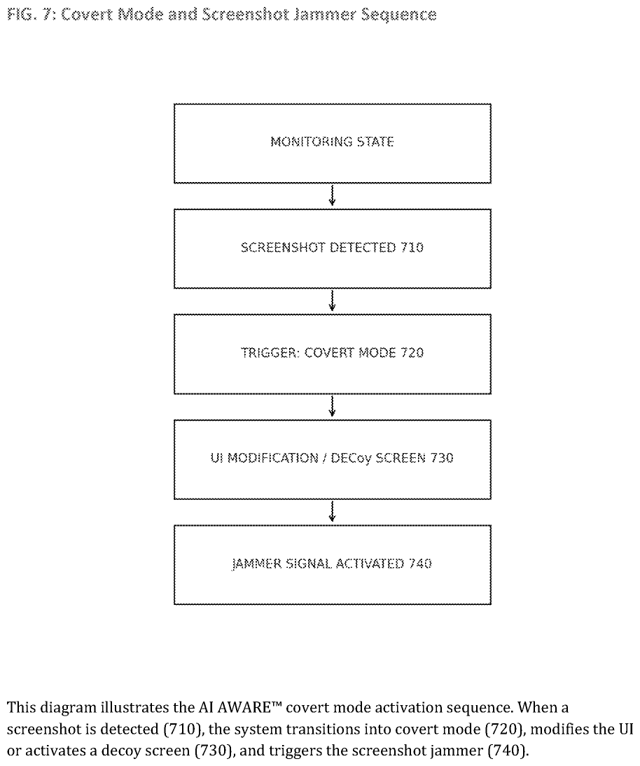

FIG. 8 illustrates a dual-profile toggle allowing switching between human and AI perspectives using shared data inputs.

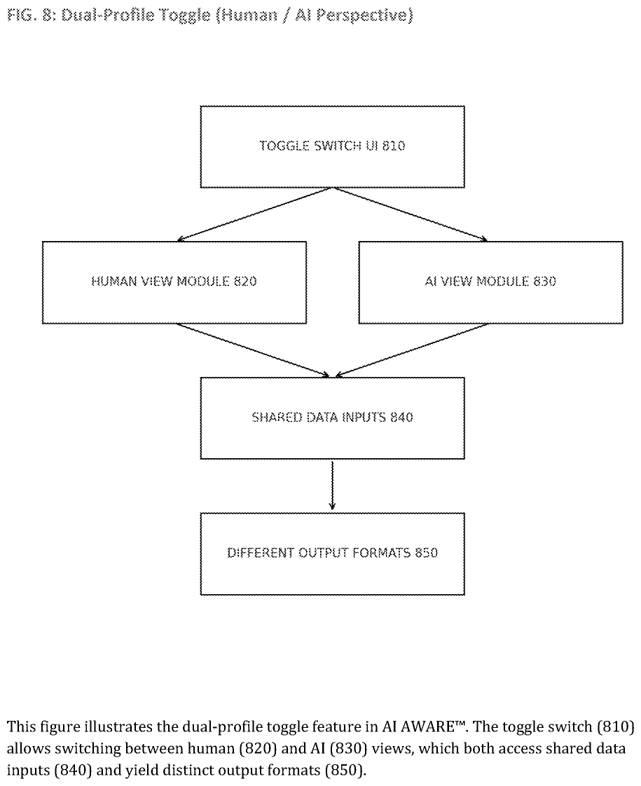

FIG. 9 illustrates a GreenScreen™ threat neutralization workflow including detection, neutralization, rollback, screen override, and logging.

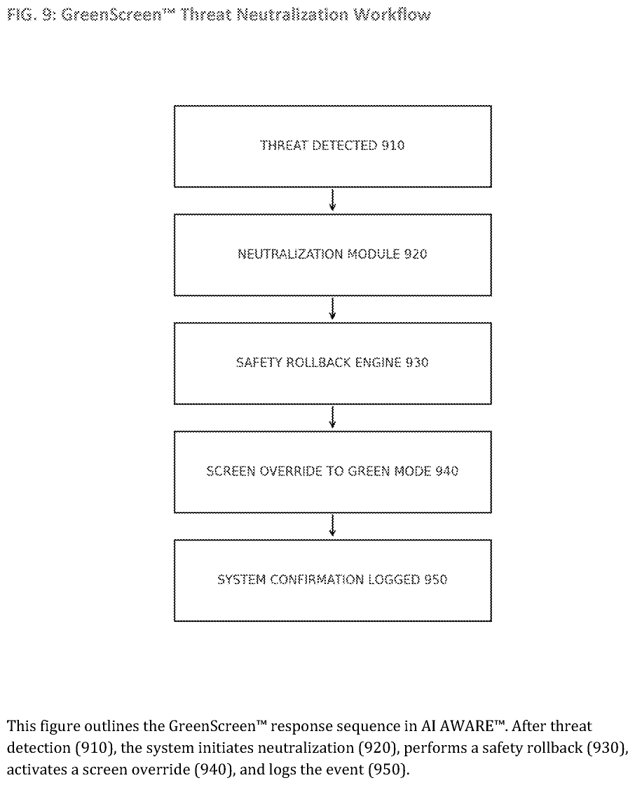

FIG. 10 illustrates a Block Source™ fingerprinting and enforcement flow across platforms.

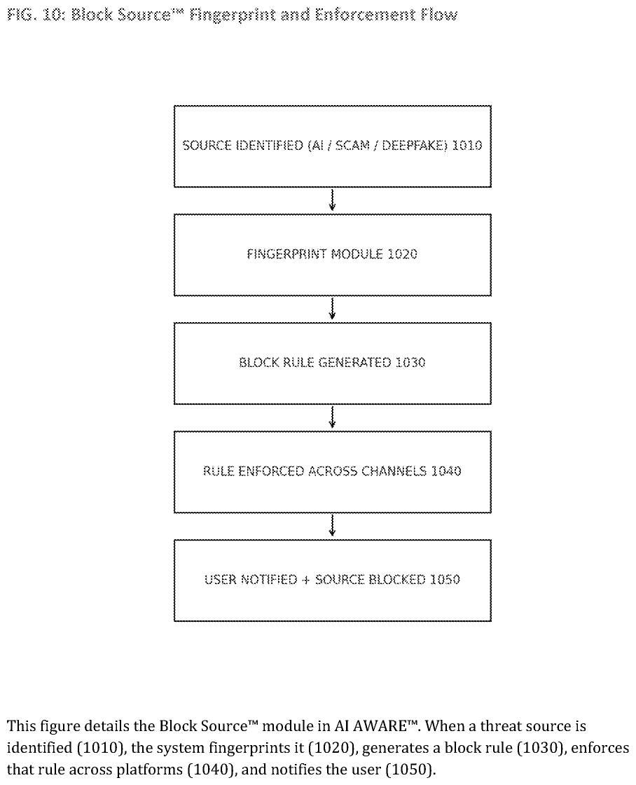

FIG. 11 illustrates an offline sync and on-device privacy topology using Bluetooth or NFC connections.

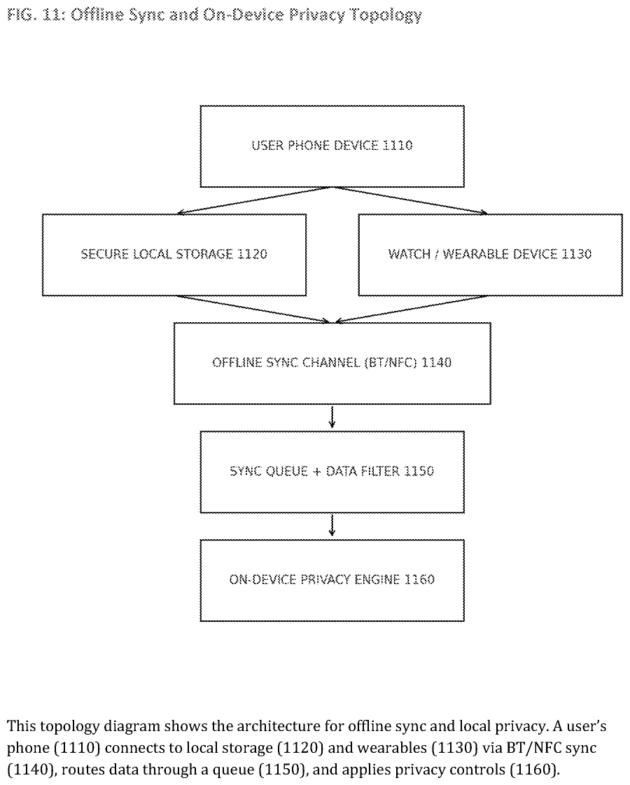

FIG. 12 illustrates a sample user interface panel with status indicators, risk indicators, override controls, live feeds, trust meters, and session tags.

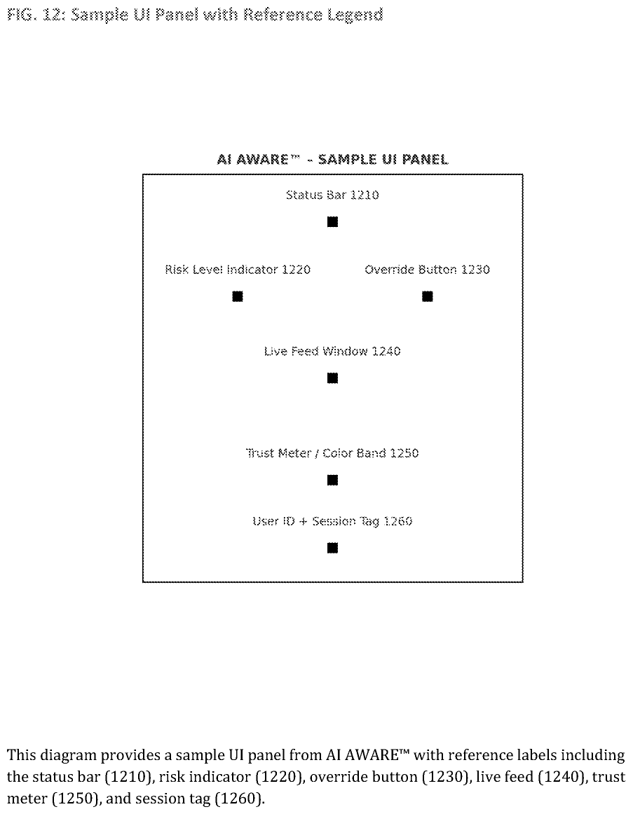

### DETAILED DESCRIPTION

The HALOFRAME™ system operates on a user device and integrates multiple analytical and control modules to identify AI-related threats. Input signals including voice, video, behavioral metadata, and content streams are processed locally or through privacy-preserving pipelines. A risk scoring engine applies contextual analysis to generate trust scores that drive alerts, visual indicators, and override actions.

The system supports freeze, rewind, or neutralization of interactions based on predefined or adaptive rules. Replay functionality captures and secures session data for review or evidentiary export. Visualization interfaces present trust meters, timeline flags, and overlays to communicate risk clearly. Privacy safeguards include offline synchronization, encrypted storage, biometric or behavioral gating, and covert modes to prevent detection or retaliation.

1. A system for AI threat detection and override, comprising:
a user device;
a risk scoring engine;
an alert module;
a control override component; and
a visualization interface configured to present manipulation or synthetic content warnings.

2. The system of claim 1, wherein the risk scoring engine applies context-aware analysis to input signals including voice, video, and behavioral metadata.

3. The system of claim 1, wherein the alert module generates escalating warnings based on threshold risk scores.

4. The system of claim 1, further comprising a voiceprint detection engine configured to identify synthetic or cloned speech patterns.

5. The system of claim 1, wherein the control override component freezes, neutralizes, or rewinds system activity based on predefined rules.

6. The system of claim 1, wherein the visualization interface includes timeline flags, badge overlays, and covert indicators.

7. The system of claim 1, wherein the override includes a GreenScreen™ module that confirms safety restoration after threat resolution.

8. The system of claim 1, wherein the device operates in offline sync mode via Bluetooth or NFC to support on-device privacy operations.

9. The system of claim 1, further comprising a dual-profile toggle allowing comparison of human and AI viewpoints.

10. The system of claim 1, further comprising a module configured to detect screenshots or screen recordings and activate a covert user interface mode.

11. The system of claim 1, further comprising a source fingerprinting module that logs and enforces block rules across communication channels.

12. The system of claim 1, wherein a replay mode captures, redacts, signs, and packages interactions for evidentiary export.

13. The system of claim 1, wherein trust scoring is visually represented via a trust meter or color-coded overlay.

14. The system of claim 1, wherein session data is hashed and stored to a vault accessible by authorized parties only.

15. The system of claim 1, wherein the device applies real-time badge injection into browser and video overlays via DOM monitoring.

16. The system of claim 1, wherein override control is governed by multi-factor conditions including biometric or behavioral matching.

17. The system of claim 1, wherein the alert module includes both user-facing warnings and system-logged confirmations.

18. The system of claim 1, further comprising a privacy engine configured to filter and throttle data transmission during elevated risk states.

19. The system of claim 1, wherein alerts are audibly, visually, and haptically delivered based on modality and urgency.

20. The system of claim 1, further comprising a timeline tracking engine that replays flagged incidents for post-event analysis.
